(19) United States
(12) Patent Application Publication
(10) Pub. No.: US 2006/0288007 A1
(43) Pub. Date: Dec. 21, 2006

(54) Telecommunications system using secured domain name resolution

(76) Inventor: Daniel Migault, Issy Les Moulineaux (FR)

Correspondence Address: Gerald E Helget;Briggs and Morgan, Suite 2200, 80 South Eight Street, Minneapolis, MN, 55402, US

(21) Appl. No.: 10/572,608

(22) PCT Filed: Sep. 23, 2004
(86) PCT No.: PCT/FR04/02397

§ 371 Date: Apr. 17, 2006

(30) Foreign Application Priority Data
Sep. 26, 2003 (FR) 0311350

(51) Int. Cl. G06F 17/30

(52) U.S. Cl. 707/9

(57) ABSTRACT

The invention concerns a telecommunications system including a database DBS comprising a reference server REFS containing data associated with at least one domain name, and at least one first and second auxiliary server CFS and PBS intended to contain data CONFD and PUBD respectively provided with a first and second degree of confidentiality. At least one of the auxiliary servers is provided with identification means IDMC, IDMP for preventing any access to the data that it contains by terminals not having access authorisation compatible with the degree of confidentiality attributed to the data contained in this auxiliary server.

The invention provides respect for the confidential character which certain data CONFD stored in a database DBS accessible by means of a terminal TER0, TER1 or TER2 via a public network could have.

The present invention concerns a telecommunications system including a database intended to be connected to at least one terminal by means of a communication network, and the said database including data associated with at least one domain name.

Such databases are normally used in telecommunications systems using one or more public linked networks, systems in which a terminal knowing the domain name of a given caller will interrogate a database by means of this domain name in order to obtain a current protocol address that may be caused to vary over time, for example an IP address if an Internet network is being used. To this end, the database keeps up to date a lookup table between various domain names and protocol addresses associated with these domain names. Such a service for supplying current protocol addresses associated with known domain names of calling terminals is known to persons skilled in the art by the abbreviation DNS, from the English expression “Domain Name Service”, the database being in principle stored wit in a server normally referred to as DNS server and, by matching a domain name and a protocol address associated with this domain name, performing an operation known as resolution.

In certain applications, confidential data can be associated with a domain name appearing in the database stored in the DNS server. Such confidential data can simply consist of a particular protocol addresses which must be kept secret and cannot be communicated except to a previously defined restricted population. The confidential data can also consist of profile information peculiar to the holder of a site identified by the domain name in question, or technical information peculiar to the site itself.

However, in the prior art, the DNS server, which functions like an associative memory addressable by means of the domain name, operates no filtering of the information that it retrieves in response to a request identifying a given domain name, so that respecting the confidential character of some data is in no cases guaranteed.

One of the aims of the invention is to permit the performance of a protocol address service which ensures respect for the confidential character that some data stored in a database in correspondence with one or more domain names associated with the said protocol addresses may have.

This is because a telecommunication system according to the introductory paragraph is characterised according to the invention in that the database includes a so-called reference server, intended to contain data associated with at least one domain name, and at least one first and one second auxiliary server intended to contain data previously recorded within the reference server and respectively provided with a first and second degree of confidentiality, at least one of the first and second auxiliary servers being provided with identification means for preventing any access to the data that it contains by terminals not having access authorisation compatible with the degree of confidentiality attributed to the data contained in this auxiliary server.

The invention makes it possible to exercise control over the conditions of communication to the public of information contained in the database, by separating the data initially contained in the reference server into at least two groups of data having different degrees of confidentiality, the said groups being respectively intended to be contained in distinct auxiliary servers accessible to previously defined populations, which can be specific to each auxiliary server and different from one auxiliary server to another.

The database will advantageously be provided with means of duplicating the data contained in the reference server to the first and second auxiliary servers according to the degrees of confidentiality attributed to the said data.

The duplication to the auxiliary servers of the information contained in the reference server will allow consultation of this information at the auxiliary servers, allowing the preservation of a backup version of this information within the reference server.

The first and second auxiliary servers will advantageously be provided with identification means for preventing any access to the data contained in the first and second auxiliary servers to terminals not having access authorisations respectively compatible with the first and second degrees of confidentiality.

The identification means constitute a simple means of restricting access to the information contained in a given server, since they require each terminal having required access to provide evidence of its right of access, and thus exempt the server from any search for additional information with a view to establishing the existence or non-existence of this right.

Other access restriction means, such as means of locating the terminal that emitted an access request, can of course be used to prevent access to data by terminals not having an access authorisation compatible with the degree of confidentiality attributed to the said data, the compatibility being of a geographical nature in this other example.

The reference server can be inaccessible in read mode and write mode, to all external terminals, apart from certain items of control equipment belonging to a manager of the system that must be capable of dynamically modifying, deleting or adding protocol addresses, as well as possibly confidential data relating to domain names included in the database. Such inaccessibility guarantees a certain degree of integrity of the data contained in the reference server, whether or not these data are confidential.

In order to confer on the database according to the invention an additional degree of freedom for its functioning, it will however be possible to authorise access in read mode only to the data contained in the reference server. To this end, the reference server will be provided with identification means for preventing any reading of data contained in the said reference server from terminals not having access authorisation compatible with a third degree of confidentiality.

In order to preserve to the maximum possible extent the integrity of the data contained in the reference server to which access in read mode is thus made possible, the third degree of confidentiality will have a restrictive effect greater than the restrictive effects produced by the first and second degrees of confidentiality.

The population able to directly read the information contained in the reference server will thus be less numerous than the population authorised to consult the auxiliary servers.

For the same reason of preservation of the integrity of the data that it is intended to contain, the reference server will preferably be provided with identification means for preventing any writing of data in the said reference server from a terminal not having access authorisation compatible with a greater degree of confidentiality having a restrictive effect greater than the restrictive effects produced by all the other degrees of confidentiality attributed to the data contained in the reference server and in the auxiliary servers.

The invention also concerns, as a means essential for its implementation, an information storage device including a so-called reference server, and at least a first and second auxiliary server intended to contain data previously recorded within the reference server and respectively provided with a first and second degree of confidentiality, at least one of the first and second auxiliary servers being provided with identification means for preventing any access to the data that they contain to applicants not having an access authorisation compatible with the degree of confidentiality attributed to the data contained in this auxiliary server.

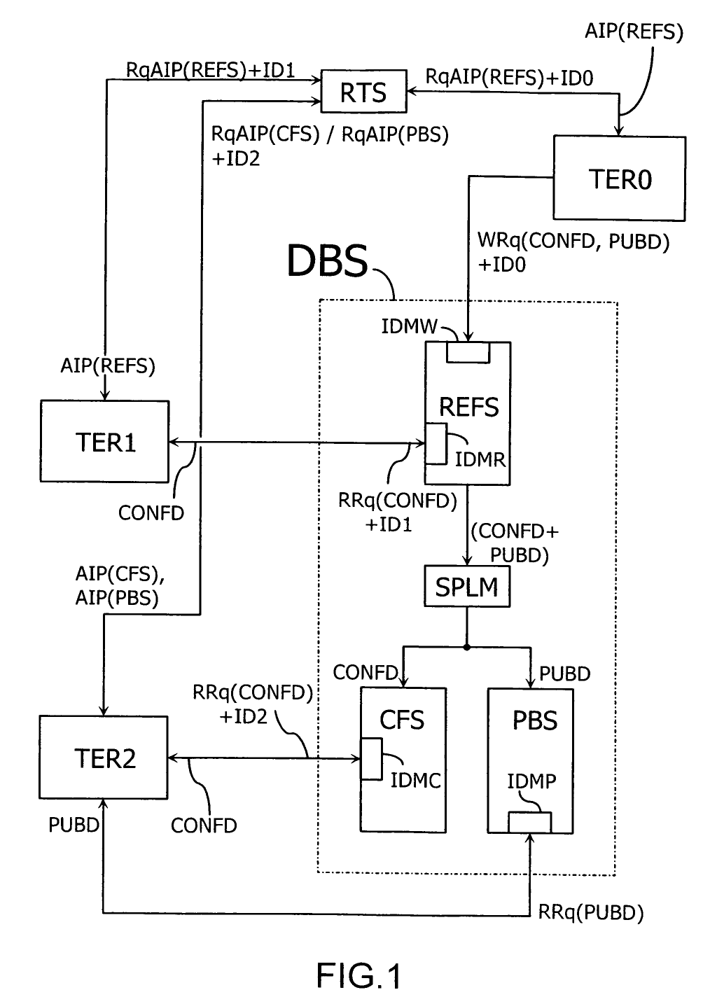

The characteristics of the invention mentioned above, as well as others, will emerge more clearly from a reading of the following description of an example embodiment, the said description being given in relation to FIG. 1, which is a functional diagram depicting, in simplified form, a telecommunications system in which the invention is implemented.

This telecommunications system includes a database DBS intended to be connected to at least one terminal TER0, TER1 or TER2 by means of a communication network, for example a linked network of the Internet type. In this particular embodiment of the invention, the database DBS includes a reference server REFS intended to contain data associated with at least one domain name, and first and second auxiliary servers CFS and PBS intended to contain data previously recorded within the reference server and respectively provided with first and second degrees of confidentiality.

To this end, each of the first and second auxiliary servers CFS and PBS is provided with identification means, respectively IDMC and IDMP, for preventing any access to the data that it contains to terminals not having access authorisation compatible with the degree of confidentiality attributed to the data CONFD or PUBD contained in this auxiliary server CFS or PBS.

The first and second degrees of confidentiality will in principle be chosen so that they will define two different populations, the population authorised to access the confidential data CONFD contained in the first auxiliary server CFS being through this choice of size very much less than the population authorised to access the public data PUBD contained in the second auxiliary server PBS.

In a simplified case of such an embodiment of the invention only the data CONFD contained in the first auxiliary server CFS will be confidential data, in contradistinction to the data PUBD contained in the second auxiliary server PBS, which will be public data. In such a simplified case, the identification means IDMP mentioned above may be non-existent or simply able to control compliance with form conditions to which applications Rq(PUBD) to read the public data PUBD contained in the second auxiliary server PBS would be subject.

When a terminal TER2 wishes to consult data contained in the first auxiliary server CFS, the said terminal will first of all send a request RqAIP(CFS) to a root server RTS for the purpose of having the protocol address AIP(CFS) of this first auxiliary server CFS communicated to it. This request RqAIP(CFS) will usually be accompanied by an identifier ID2 of this terminal TER2. The terminal TER2 will then send, to this protocol address AIP(CFS), a request RRq(CONFD) to read information CONFD identified by the domain name associated with them and which is known to the terminal TER2. This request RRq(CONFD) will be accompanied by the identifier ID2 and will reach the first auxiliary server CFS via the identification means IDMC with which it is provided. If the identifier ID2 identifies the terminal TER2 as belonging to the population authorised to access the data CONFD provided with the first degree of confidentiality and considered to be confidential in this example, the required data CONFD will be transmitted in return to the terminal TER2. In the contrary case, the identification means IDMC will be able to send to the terminal TER2 a notice of inadmissibility, or simply put an end to the connection between the terminal TER2 and the first auxiliary server CFS. The requests and messages described above will advantageously pass via the Internet, in which case the protocol addresses will be IP addresses.

When the terminal TER2 wishes to consult data contained in the second auxiliary server PBS, the said terminal will first of all send a request RqAIP(PBS), accompanied by the identifier ID2, to the root server RTS for the purpose of having the protocol address AIP(PBS) of this second auxiliary server PBS communicated to it. The terminal TER2 will then be able to send, to this protocol address AIP(PBS), a request RRq(PUBD) to read information PUBD identified by the domain name which is associated with it and which is known to the terminal TER2. This request RRq(PUBD) will reach the second auxiliary server PBS via the identification means IDMP with which it is provided. The data contained in the second auxiliary server PBS being public in the simplified case described here, the identifier ID2 of the terminal T2 is not necessary for obtaining access to these data PUBD, which will automatically be transmitted in return to the terminal TER2, unless the read request RRq(PUBD) has a defect in form which is detected by the identification means IDMP. Any terminal making a request to read data PUBD contained in the second auxiliary server PBS is thus presumed to possess access authorisation compatible with the very low degree of confidentiality which is attributed in this example to the said data PUBD.

Each of the first and second auxiliary servers CFS and PBS will be able to be constructed according to a master/slave architecture well known to persons skilled in the art, and thus include one or more slave servers, not shown here and arranged in parallel under the control of a single master server, which will enjoy exclusive competence for executing a write request in one of the slave servers that it controls.

In the particular embodiment of the invention described here, the database DBS is provided with means SPLM of duplicating the data CONFD, PUBD contained in the reference server REFS to the first and second auxiliary servers CFS and PBS according to the degrees of confidentiality attributed to the said data.

The duplication to the auxiliary servers CFS and PBS of the data CONFD, PUBD contained in the reference server REFS will allow consultation of these data CONFD, PUBD at the auxiliary servers CFS and PBS, allowing the preservation of a backup version of these data within the reference server REFS.

In order to execute such a distribution of the copies the data CONFD, PUBD, the duplication means SPLM can implement a distribution function intended to analyse a distribution field associated with each data item and intended to contain a value representing the degree of confidentiality attributed to the said data item. Thus, in the simplified case described above where the data are considered either to be public or to be confidential, the distribution field can for example contain only one bit equal to “0” if it is associated with a public data item PUBD or to “1” in the case of a confidential data item CONFD.

In the particular embodiment of the invention described here, an additional access, but only in read mode, to the data contained in the reference server REFS has been provided in order to confer an additional degree of freedom on the database DBS for its functioning. To this end, the reference server REFS is provided with identification means IDMR in order to prevent any reading of the data contained in the said reference server REFS from terminals not possessing any access authorisation compatible with a third degree of confidentiality.

In order best to preserve the integrity of the data contained in the reference server REFS to which access in read mode is thus made possible, the third degree of confidentiality will have a restrictive effect greater than the restrictive effects produced by the first and second degrees of confidentiality. The population able to directly read the information contained in the reference server REFS will thus be less numerous than the populations authorised to consult the auxiliary servers CFS and PBS.

When a terminal TER1 wishes to consult data contained in the reference server REFS, the said terminal TER1 will first of all send a read request RqAIP(REFS) to the root server RTS for the purpose of having the protocol address AIP(REFS) of this reference server REFS communicated to it. This read request RqAIP(REFS) will usually be accompanied by the identifier ID1 of this terminal TER1. The terminal TER1 can then send to this protocol address AIP(REFS) a request RRq(CONFD) to read information CONFD identified by the domain name associated with it and which is known to the terminal TER1. This request RRq(CONFD) will be accompanied by the identifier ID1 and will reach the reference server REFS providing the identification means IDMR with which it is provided. If the identifier ID1 identifies the terminal TER1 as belonging to the population provided with the third degree of confidentiality, the required data CONFD will be transmitted in return to the terminal TER1. In the contrary case, the identification means IDMR will be able to send an inadmissibility notice to the terminal TER1, or simply put an end to the connection between the terminal TER1 and the reference server REFS.

The procedure described above is also applicable to the direct reading of public data contained in the reference server REFS.

With a constant desire to preserve the integrity of the data that it is intended to contain, the reference server REFS is here provided with identification means IDMW in order to prevent any writing of data in the said reference server REFS from a terminal TER0 not possessing any access authorisation compatible with a degree of confidentiality having a restrictive effect greater than the restrictive effects produced by all the other degrees of confidentiality attributed to the data contained in the reference server and in the auxiliary servers.

The population able to write or modify data in the reference server REFS will thus be even less numerous than the populations solely authorised to read directly information contained in the reference server REFS, and, all the more so, much less numerous than the populations authorised to consult the auxiliary servers CFS and PBS.

When a terminal TER0 wishes to write data in the reference server REFS or modify data contained in the reference server REFS, the said terminal TER0 will first of all send a request RqAIP(REFS) to the root server RTS for the purpose of having the protocol address AIP(REFS) of this reference server REFS communicated to it. This request RqAIP(REFS) will usually be accompanied by the identifier ID0 of this terminal TER0. The terminal TER0 can then send, to this protocol address AIP(REFS), a request WRq(CONFD, PUBD) to write confidential or public information intended to be identified by a domain name associated with it, which write request WRq(CONFD, PUBD) will be accompanied by the identifier ID0 and will reach the reference server REFS via additional identification means IDMW with which it is provided. If the identifier ID0 identifies the terminal TER0 as belonging to the very restricted population authorised to write data in the reference server REFS, the data CONFD, PUBD will be entered at an address specified in the write request WRq(CONFD, PUBD), which will represent the domain name associated with the data CONFD, PUBD. In the contrary case, the identification means IDMR will be able to send an inadmissibility notice to the terminal TER0 or simply put an end to the connection between the terminal TER0 and the reference server REFS.

The invention described above therefore makes it possible to perform a protocol address supply service which ensures respect for the confidential character that certain data CONFD stored in the database DBS in correspondence with one or more domain names associated with the said protocol addresses may have.

1. A telecommunications system comprising a database intended to be connected to at least one terminal by means of a communication network, the database including a so-called reference server, intended to contain data associated with at least one domain name, and at least one first and one second auxiliary server intended to contain data previously recorded within the reference server and respectively provided with a first and second degree of confidentiality, at least one of the first and second auxiliary servers being provided with identification means for preventing any access to the data that it contains by terminals not having access authorisation compatible with the degree of confidentiality attributed to the data contained in this auxiliary server.

2. The telecommunications system of claim 1, comprised in that the database is provided with means of duplicating the data contained in the reference server to the first and second auxiliary servers according to the degrees of confidentiality attributed to the said data.

3. The telecommunications system of claim 1, comprised in that the first and second auxiliary servers are provided with identification means to prevent any access to the data contained in the first and second auxiliary servers by terminals not having access authorisations respectively compatible with the first and second degrees of confidentiality.

4. The telecommunications system of claim 1, comprised in that the reference server is provided with identification means for preventing of any reading of data contained in the said reference server from terminals not having access authorisation compatible with the third degree of confidentiality.

5. The telecommunications system of claim 1, comprised in that the third degree of confidentiality has a restrictive effect greater than the restrictive effects produced by the first and second degrees of confidentiality.

6. The telecommunications system of claim 1, comprised in that the reference server is provided with identification means for preventing any writing of data in the said reference server from a terminal not having access authorisation compatible with a greater degree of confidentiality having a restrictive effect greater than the restrictive effect produced by all the other degrees of confidentiality attributed to the data contained in the reference server and the auxiliary servers.

7. A device for storing information comprising a so-called reference server and at least a first and second auxiliary server intended to contain data previously recorded within the reference server and respectively provided with a first and second degree of confidentiality, at least one of the first and second auxiliary servers being provided with identification means for preventing any access to the data that they contain by applicants not having access authorisation compatible with the degree of confidentiality attributed to the data contained in this auxiliary server.
